(19) United States
(12) Patent Application Publication
(10) Pub. No.: US 2023/0169881 A1
(43) Pub. Date: Jun. 1, 2023

(54) VIRTUAL REALITY SHOOTER TRAINING SYSTEM

(71) Applicant: Overmatch, Inc., Plano, TX (US)

(72) Inventors: Ryan Evans, Plano, TX (US); Brenden Tennant, Plano, TX (US)

(21) Appl. No.: 17/981,190

(22) Filed: Nov. 4, 2022

Related U.S. Application Data
(60) Provisional application No. 63/283,640, filed on Nov. 29, 2021.

(51) Int. Cl. G09B 9/00; G06F 3/01; G06T 19/00

(52) U.S. Cl. CPC G09B 9/003; G06F 3/016; G06T 19/006

(57) ABSTRACT

A system for providing an augmented reality/virtual reality (AR/VR) environment, includes an AR/VR server for providing an AR/VR environment responsive to scanned environment data, control data and user device data. A portable user device associated with the AR/VR server generates user device data for transmission to the AR/VR server and displays the AR/VR environment to a user associated with the portable user device. The AR/VR server is further configured to receive scanned environment data from at least one scanning device, the scanned environment data representing a physical environment, generate the AR/VR environment responsive to the scanned environment data, create a scenario within the generated AR/VR environment responsive to control data provided to AR/VR server, track a position of an object held by the user responsive to feedback from the object to the portable user device and control the position of the object within the AR/VR environment responsive to the tracked position of the object by the portable user device.

### CROSS-REFERENCE TO RELATED APPLICATIONS

This application claims the benefit of U.S. Pat. Application No. 63/283,640, filed Nov. 29, 2021, entitled VIRTUAL REALITY SHOOTER TRAINING SYSTEM (Atty. Dkt. No. OVER04-00005), which is incorporated by reference herein in its entirety.

### TECHNICAL FIELD

The present invention relates to augmented reality/virtual reality systems, and more particularly, to a system enabling controllable types of training of individuals using augmented reality/virtual reality systems.

### BACKGROUND

Augmented reality and virtual reality systems have seen a large growth in a variety of educational, training and entertainment applications. One area of great potential application for augmented reality and virtual reality systems is within training of individuals in high risk scenarios. The ability to train people in, for example, high risk shooting or driving environments enable the individuals to be better trained to react to high stress situations. The ability to adapt and control the virtual reality system to improve the training regimen enables such a system to provide a much higher quality of training than those that are currently available.

### SUMMARY

The present invention, as disclosed and described herein, in one aspect there of, comprises a system for providing an augmented reality/virtual reality (AR/VR) environment. An AR/VR server provides an AR/VR environment responsive to scanned environment data, control data and user device data. A portable user device associated with the AR/VR server generates user device data for transmission to the AR/VR server and displays the AR/VR environment to a user associated with the portable user device. The AR/VR server is further configured to receive scanned environment data from at least one scanning device, the scanned environment data representing a physical environment, generate the AR/VR environment responsive to the scanned environment data, create a scenario within the generated AR/VR environment responsive to control data provided to AR/VR server, track a position of an object held by the user responsive to feedback from the object to the portable user device and control the position of the object within the AR/VR environment responsive to the tracked position of the object by the portable user device.

### BRIEF DESCRIPTION OF THE DRAWINGS

For a more complete understanding, reference is now made to the following description taken in conjunction with the accompanying Drawings in which:

FIG. 1 illustrates a general block diagram of an augmented reality/virtual reality platform architecture;

FIG. 2 illustrates the interaction between the platform level and application level for an augmented reality/virtual reality platform;

FIG. 3 illustrates the various capabilities of the augmented reality/virtual reality platform;

FIG. 4 illustrates a more detailed description of the various capabilities;

FIG. 5A illustrates a functional block diagram of the AR/VR system platform;

FIG. 5B illustrates a block diagram of the vest and headset unit of the augmented reality/virtual reality system;

FIG. 6 illustrates a block diagram of the headset;

FIG. 7 illustrates a perspective view of the headset and gun tracking unit;

FIG. 8 illustrates a perspective view of the various components of the vest unit;

FIG. 9 illustrates a front view of a rifle tracker;

FIG. 10 illustrates a side view of the rifle tracker;

FIG. 11 illustrates a perspective view of the rifle tracker;

FIG. 12 illustrates a perspective view of a pistol tracker;

FIG. 13 illustrates a front view of the pistol tracker;

FIG. 14 illustrates the overall system operation of the augmented reality/virtual reality platform;

FIG. 15A illustrates a process for creating an augmented reality/virtual reality environment from multiple scanning devices;

FIG. 15B illustrates the components for scanning an environment and using a central server to generate a AR/VR representation thereof;

FIG. 16 illustrates a flow diagram of the process for localizing end-user devices with the central server;

FIG. 17 illustrates a flow diagram of the process for using multiple devices to create an augmented reality/virtual reality environment;

FIG. 18 illustrates a flow diagram of the process of capturing an area and creating an augmented reality/virtual reality environment from the captured data;

FIG. 19 illustrates a block diagram of the various functionalities of the augmented reality/virtual reality platform;

FIG. 20 illustrates the various manners for controlling an environment within the augmented reality/virtual reality system;

FIG. 21 illustrates various functions which may be controlled within a shooting game during a scenario replay;

FIG. 22 illustrates various use cases of the augmented reality/virtual reality platform;

FIG. 23A illustrates a screenshot of a biometric data capture;

FIGS. 23B-23D illustrates the trainer POV eye tracking for a user;

FIG. 23E illustrates the biometric data capture for eye tracking; and

FIG. 23F illustrates the biometric data capture for view direction.

### DETAILED DESCRIPTION

Referring now to the drawings, wherein like reference numbers are used herein to designate like elements throughout, the various views and embodiments of a virtual reality training system are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

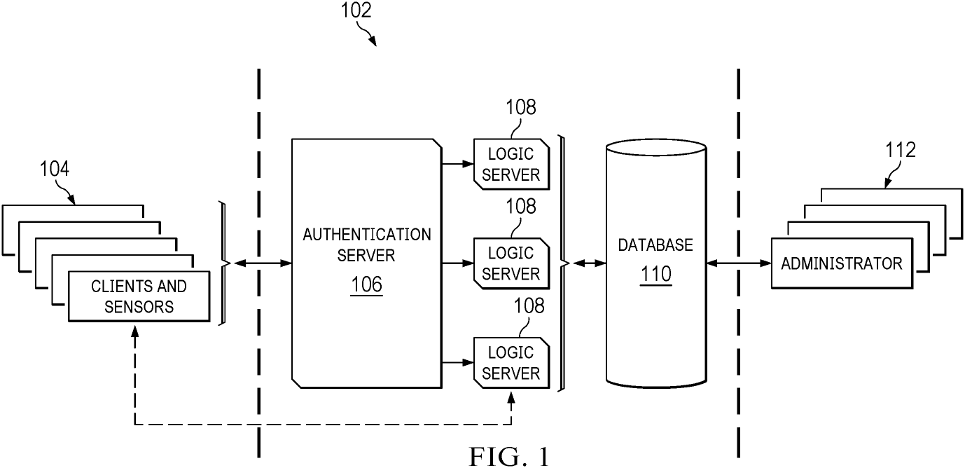

FIG. 1 illustrates a top-level view of the augmented reality/virtual reality (AR/VR) platform architecture 102. A plurality of clients and sensors 104 are used for gathering data that defines an area for display within the virtual reality (VR) environment. The clients and sensors 104 may obtain data from a real-world environment that is uploaded for use in creating the VR environment. The data that is gathered by the plurality of clients and sensors 104 is uploaded to an authentication server 106. The authentications server 106 confirms the validity of the provided data and passes it on to one or more logic servers 108 for creation of the virtual reality environment. The logic servers 108 store the created VR data with in a database 110. The information within the database 110 may then be manipulated using administrative functionalities 112 as will be more fully described herein below.

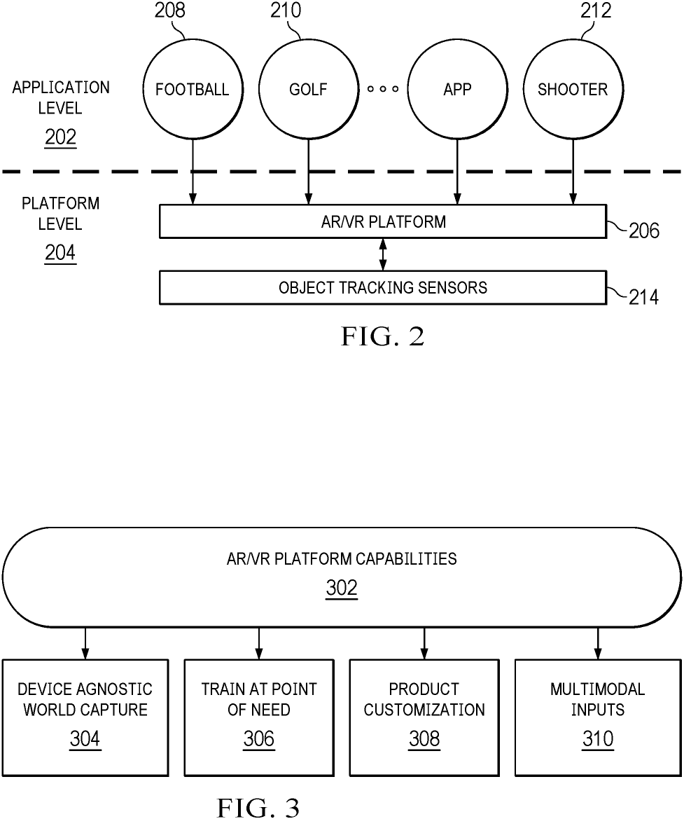

Referring now to FIG. 2, there is illustrated the separation between the application level 202 and the platform level 204 of the AR/VR system. The AR/VR system platform 206 resides upon the platform level 204 and provides all the functionalities for controlling and generating the presentation of an AR/VR environment to a particular user. The AR/VR system platform 206 has its operation controlled by a variety of applications 208-212 that are present on the application level 202. The AR/VR system platform 206 provides for telemetry capture, role-playing/scenario creation, data visualization and a software development kit (SDK). The applications include the various functionalities needed to present a particular type of AR/VR environment to a user of the AR/VR system platform 206. These applications can comprise any number of applications such as a football application 208, golf application 210, shooter application 212, etc. The applications provide the necessary environmental and control parameters for displaying a particular AR/VR environment to a user. The environmental and control parameters are provided to the AR/VR system platform 206 which generates the actual AR/VR environment responsive to these parameters. The applications may be commercial based for use with location-based entertainment or professional sports training or alternatively, training based for dynamic scenario simulation and real-time performance feedback of, for example, military or police training. Other applications will of course be utilized. The object tracking sensor systems 214 will provide for a variety of tracking types including the use of commercial off-the-shelf AR/VR headsets, fiducial based tracking and sensor integration, as well as non-fiducial CV, RF tracking and sensor integration.

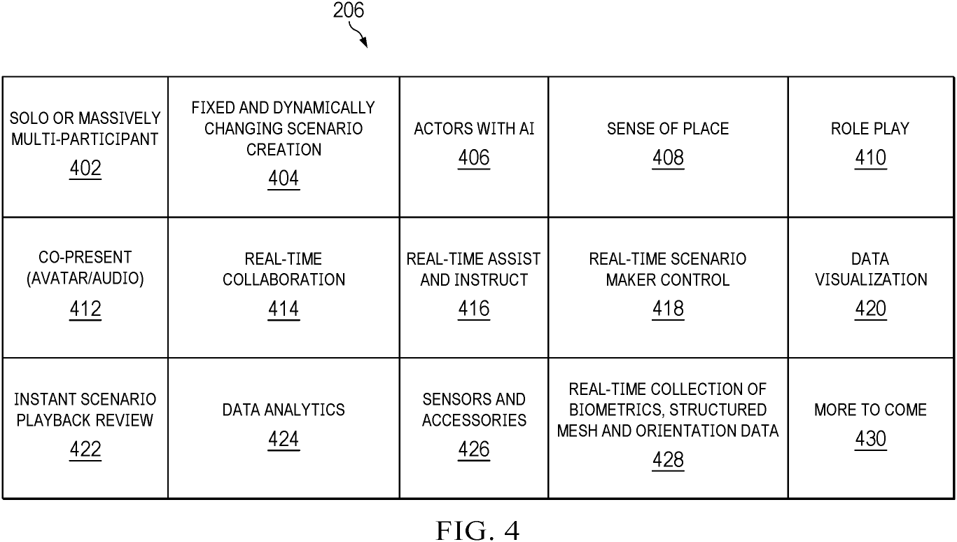

The AR/VR system platform 206 provides a variety of AR/VR system platform capabilities 302 responsive to the parameters from the applications as illustrated in FIG. 3. The AR/VR system platform capabilities 302 comprise device agnostic world capture 304, ability to train at the point of need 306, product customization 308 and multimodal inputs 310. These capabilities comprise some examples of those that may be provided by the AR/VR system platform 206, but various other types of capabilities may be provided. The device agnostic world capture functionalities 304 provide the ability for one or more users to utilize a device with associated sensor to capture depth and color data with respect to a particular physical environment. Thus, an individual may capture environment data with respect to a house, warehouse, office building, etc. wherein the user is currently located. This depth and color data may be captured and used for the creation of an AR/VR environment that mimics the physical environment where the user is currently located. The AR/VR system platform 206 can use multiple depth sensors to capture a digital twin of the world. From the depth sensors on COTS HMDs (commercial off the shelf head mounted displays) to lidar used in cars, the platform 206 can adjust depth and color data from more than one technology to create a mesh and texture of the world.

The train at the point of need functionalities 306 enables individuals to train at a particular environment that is most relevant to their particular training needs. Thus, if a group of soldiers/police officers needed to train for a rescue operation in an office building containing a particular configuration, the configuration of the office building may be used to create an AR/VR environment that mimics where the actual rescue operation will take place to provide the soldiers/police officers with a more realistic training environment. The AR/VR system platform 206 allows for lightweight infrastructure in order to reduce the physical requirements for training. This benefits those at the point of need because they do not require access to purpose built fixed structures for training. A shoot house product can fit into a large pelican case containing COTS, HMD, router, laptop and weapon sensor packs, making it a portable lightweight solution. The online features of the platform enable remote subject matter experts to engage in training from anywhere in the world.

Product customization functionalities 308 enable the system to be customized to a user’s particular entertainment or training needs. The user may set up the AR/VR environment to achieve particular goals or needs with respect to training or entertaining individuals that are currently utilizing the system. Thus, if particular scenarios are needed, they may be specifically input into the system to maximize the AR/VR environmental experience. Systems built using the AR/VR system platform 206 can be customized in real time to meet the needs of the trainer through the use of the server side AI actors, scenario generation and import of assets. Each of these toolsets allow the infinite variability for training and extends the life of the product. The client and server-side tools provide trainers complete freedom to create content on the fly as the circumstances dictate.

Multimodal inputs 310 enable various types of inputs to be provided to the AR/VR system platform 206 in order to maximize a user’s training/entertainment experience. The AR/VR system platform 206 enables users to interact with each other using a variety of different hardware platforms and sensors. Each hardware platform offers a unique way to interact with training that is exposed to the applications. Each application can use voice, video, object trackers, touchscreens and traditional mouse and keyboard. The platform 206 supports using many of these at the same time which create unique ways to train and learn in the AR/VR environment.

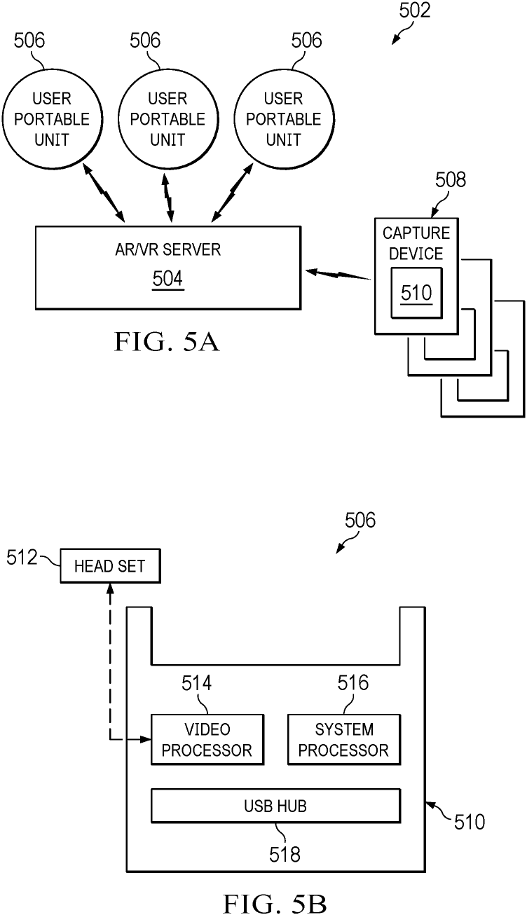

Referring now to FIG. 4, there is illustrated the various building blocks of the AR/VR system platform. The AR/VR system platform 206 will provide a real-world, multi-participant, digital, in person and remote training platform. This is achieved using a number of building blocks including solo or massively multiparticipant capabilities 402, fixed and dynamically changing scenario creation 404, actors with AI 406, sense of place 408, role-playing capabilities 410, copresent (avatar/audio) 412, real-time collaboration 414, real-time assist and instruction 416, real-time scenario maker control 418, data visualization 420, instant scenario playback and review 422, data analytics 424, sensor and accessories 426, and real-time collection of biometrics, structured mesh and orientation data 428. Other capabilities 430 would of course be possible with the AR/VR platform 206.

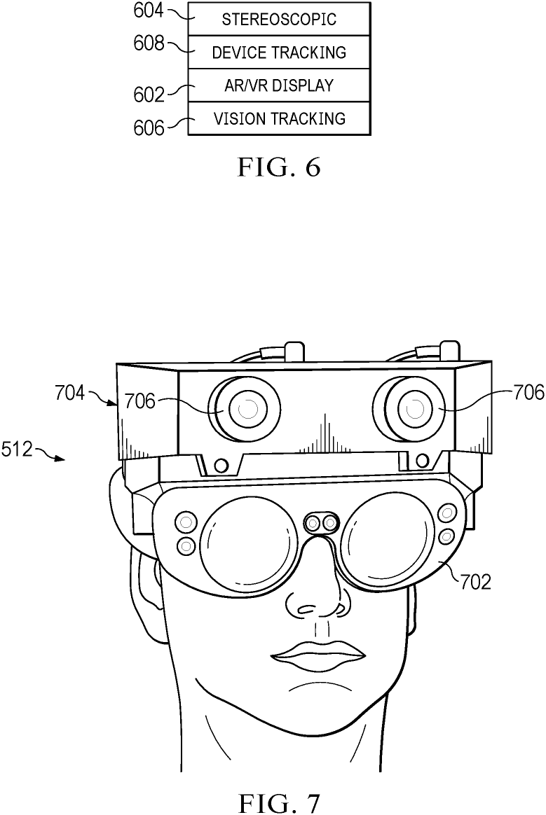

Referring now to FIG. 5A, there is illustrated a functional block diagram of the AR/VR system platform 502. An AR/VR server 504 implementing the AR/VR system platform 206 described hereinabove controls overall operation of the system. The AR/VR server 504 is wirelessly interconnected with one or more user portable units 506. The user portable units 506 are worn by a user that is being trained or entertained by the AR/VR system platform 502. The user portable units 506 consist of a headset and wearable vest components that enable a user to roam about the AR/VR environment in a non-tethered fashion. The user portable units 506 wirelessly communicate with the AR/VR server 504 in order to provide information for display to the user through their associated headset. The AR/VR server 504 further interacts with one or more capture devices 508. The capture devices 508 include sensors 510 that enable the capture of depth and color data with respect to a particular environment. This information is used by the AR/VR server 504 to generate the AR/VR environment for display to the users through the user portable unit 506.

FIG. 5B illustrates a functional block diagram of the user portable unit 506. The user portable unit 506 includes a vest portion 510 and a headset portion 512. The vest portion 510 includes a wearable vest 514 that fits over or on the body of the user. The vest portion 510 could take any number of configurations but in one example would comprise a vest including an opening at the top through which a players head would be inserted and front and back panels that rested upon the chest and back of the user which could be then secured together via straps or belts located on the sides. The vest portion 510 has mounted thereon various components such as the video processor 514, system processor 516 and USB hub 518. The video processor 514 generates the AR/VR environment signals necessary for reproducing the AR/VR environment within the headset 512 responsive to signals from a central server 504. The system processor 516 controls the operation of the playback and interaction of scenarios presented in the AR/VR environment. The system processor 516 also enables communications between the user portable unit 506 and the AR/VR server 504. A USB hub 518 enables various components upon the user portable unit 506 to be interconnected with each other through the USB hub 518.

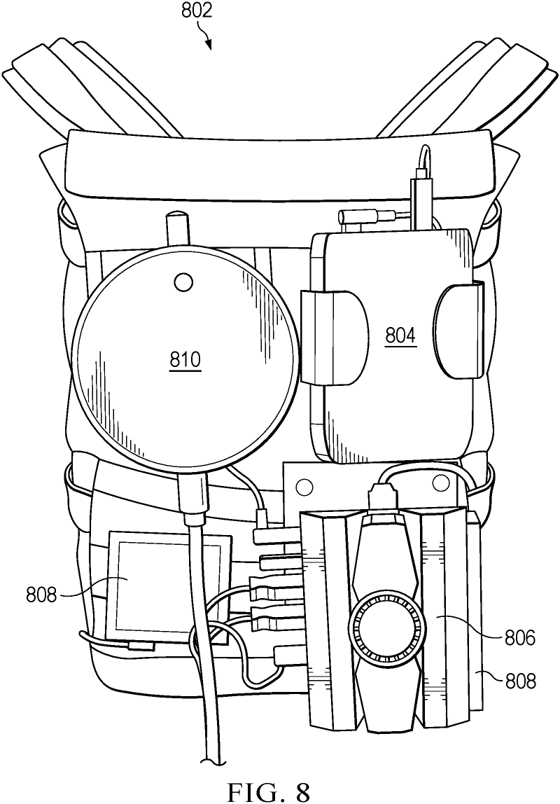

The headset 512 rests on the head of a user and covers their eyes. The AR/VR environment is displayed to the user through display screens placed over their eyes responsive to signals received from the vest portion 510. The headset 512 further provides capabilities for tracking a user’s eye and head movement based upon sensors included with the headset 512. Referring now to FIG. 6, there is a functional block diagram of the various capabilities of the headset 512. The headset 512 provides an AR/VR display 602 for displaying the AR/VR environment to the user. The headset 512 also provides stereoscopic circuitry 604 to enable the user to view the AR/VR environment in a three-dimensional world when viewing through the AR/VR display 602. The headset 512 also provides for vision tracking circuitry 606. The vision tracking circuitry 606 allow the headset to track what user is looking at with respect to the AR/VR environment being displayed upon the AR/VR display 602. The vision tracking circuitry 606 may take the form of point tracking where in the particular point a user is focused on is tracked by the headset 512. Additionally, the vision tracking circuitry 606 may take the form of tracking a cone of vision that is being viewed by a user. Thus, this would track the entire field of view based upon the direction the user was looking at through the AR/VR display 602. The headset 512 may also include device tracking circuitry 608. The device tracking circuitry 608 would track a position of a device held by the user wearing the handset. Thus, for example, if the user was holding a weapon such as a rifle or gun, sensors placed upon the weapon would be tracked by the device tracking circuitry 608 to enable the AR/VR server 504 to determine a position of the weapon with respect to the AR/VR environment. The device tracking circuitry 608 enables tracking of pointing and shooting when the weapon was being fired in the AR/VR environment. The device tracking circuitry 608 could also track the position of other items within the AR/VR environment such as a bat, tennis racket, golf club, etc. depending upon the particular application that is being utilized by the AR/VR system platform.

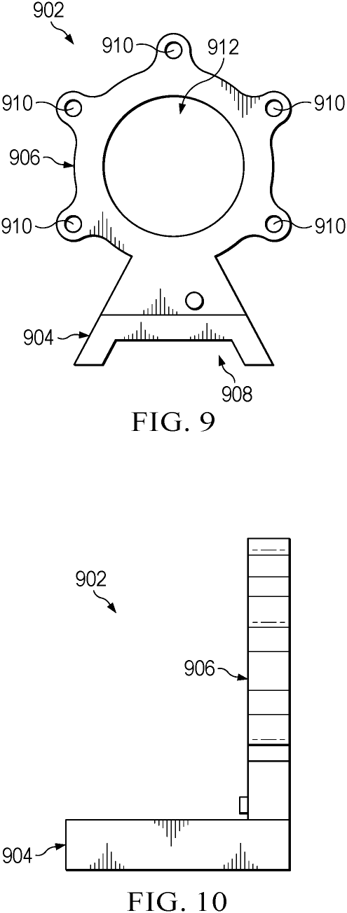

FIG. 7 illustrates the headset 512 positioned on the head of a user. The display goggles 702 provide the AR/VR display 602, stereoscopic circuitry 604 and vision tracking circuitry 606 discussed with respect to FIG. 6. The display goggles 702 cover the eyes of the user and presents only the AR/VR environment for viewing to the user. The device tracking circuitry 608 are provided by the device tracking controller 704. The device tracking controller 704 includes a pair of cameras 706 for sensing signals provided from a device sensor connected to a device normally held within the hands of a user. The device tracker controller 704 provides information necessary for the system to determine where the device is located with respect to the AR/VR environment. The device tracker controller 704 utilizes a stereo pair of cameras 706 with infrared pass filters to identify and triangulate infrared LEDs associated with the device sensors in 3-D space. These positions are used to extract a six-DLF pose for a rigid body defined by a specific placement of LEDs relative to each other. Different LED constellations are used to identify distinct rigid bodies. The pose from the rigid body is transmitted to the headset 512 and a physical position for the rigid body is calculated based upon known relative headset position. This can be used to overlay digital content on top of a physical object or make digital content react to the relative position of the physical object as will be more fully described herein below.

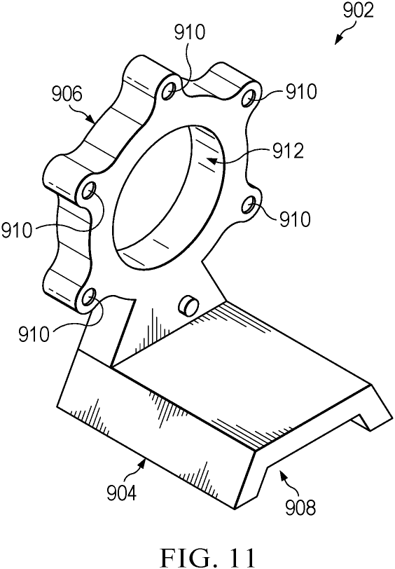

Referring now to FIG. 8, there is illustrated a wearable vest 802 onto which various system components are mounted. A battery 804 comprises a portable rechargeable battery pack for providing power to the system components. The battery 804 is rechargeable via unassociated charging port (not shown). A micro PC 806 provides for portable micro computing for processing of signals associated with the wearable vest 802 such as device tracking, display presentation responsive to receive system signals and user positioning within the VR environment. A hub 808 rests below the micro PC 806 and comprises a networking device enabling communications with the AR/VR system platform via a wireless connection. A weapons dongle 808 provides for a location for interconnecting with a weapon or other type of playing device for connection to the AR/VR system platform. In one embodiment the weapon dongle 808 comprises an Inveris Individual Weapon Server (IWS) adapter. The lightpack 810 comprises a main controller for linking together all system operating components to provide the AR/VR display to the user.

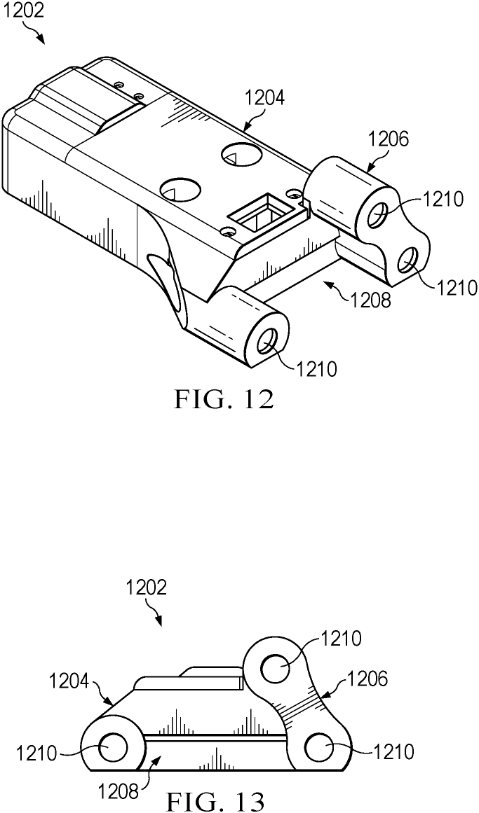

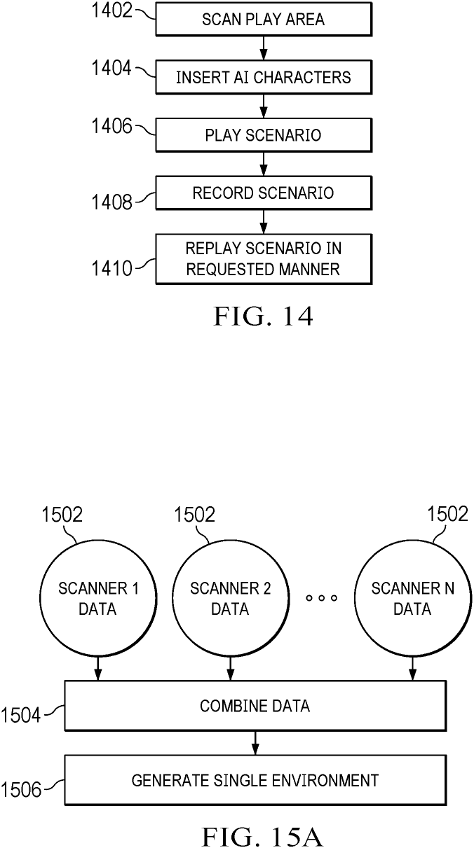

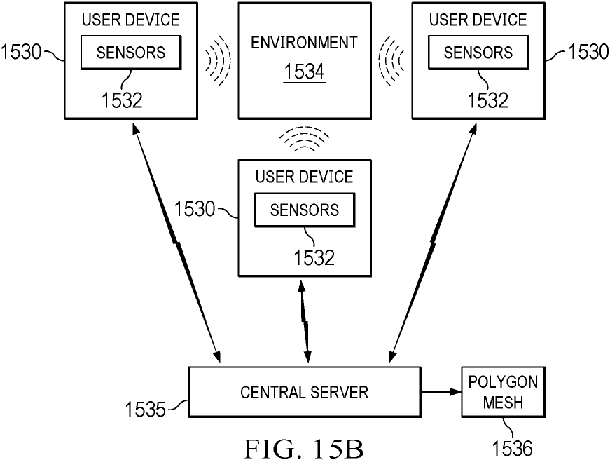

Referring now to FIGS. 9-11, there is illustrated a front view, side view and perspective view of the weapon tracker 902 for a rifle. The weapon tracker 902 attaches to a weapon rail of a rifle in order to provide for accurate weapon tracking. While FIGS. 9-11 illustrates a weapon tracker, it will be appreciated that other types of device trackers may be utilized that connect to baseball bats, tennis rackets, golf clubs, or any other devices which may be utilized within the AR/VR system platform. The weapon tracker 902 includes a rail mount portion 904 and a tracking portion 906. The rail mount portion 904 defines a slot 908 which fits over a gun rail on the rifle to which the weapon tracker 902 can be attached. The tracking portion 906 includes a plurality of LEDs 910. The LEDs 910 shine on the cameras 706 of the device tracking controller 704 enabling the pointing direction of the weapon to be determined. The tracking portion 906 further defines an opening 912 through which a user may look in order to perform aiming of the weapon.

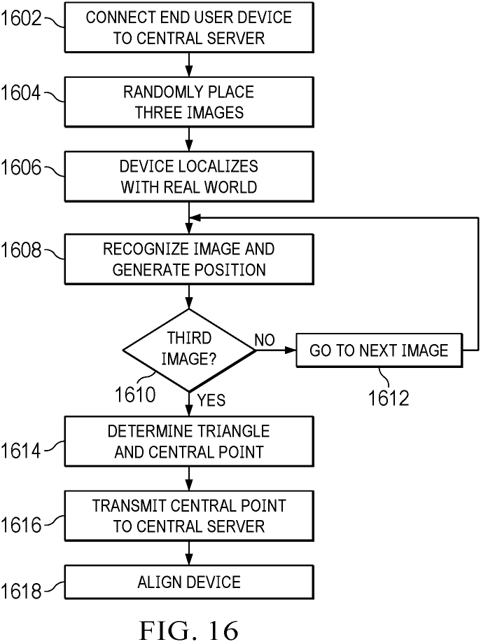

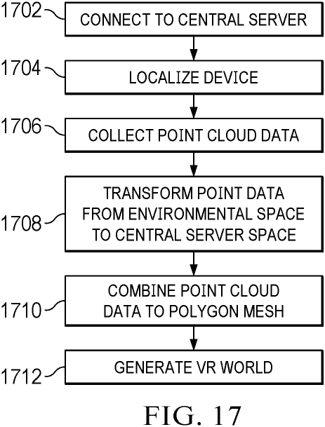

Referring now to FIGS. 12-13, there is illustrated a perspective and front view of a weapon tracker 1202 for a pistol. The weapon tracker 1202 attaches to a weapon rail of a pistol in order to provide for accurate weapon tracking. While FIGS. 12-13 illustrate a weapon tracker, it will be appreciated that other types of device trackers may be utilized that connect to baseball bats, tennis rackets, golf clubs, or any other devices which may be utilized within the AR/VR system platform. The weapon tracker 1202 includes a rail mount portion 1204 and a tracking portion 1206. The rail mount portion 1204 defines a slot 1208 which fits over a gun rail on the pistol to which the weapon tracker 1202 can be attached. The tracking portion 1206 includes a plurality of LEDs 1210. The LEDs 1210 shine on the cameras 706 of the device tracking controller 704 enabling the pointing direction of the weapon to be determined.

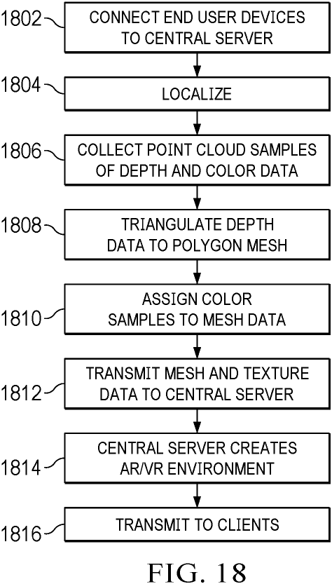

Referring now to FIG. 14, the overall operation of the AR/VR system platform is illustrated in a flow diagram. The process is initiated by users scanning the play area at step 1402 using some type of mobile scanner. AI characters are inserted at step 1404 into the AR/VR representation of the play area that has been scanned. These AI characters may be opponents or other types of characters that may be useful to the scenario displayed to a user using the AR/VR system platform. Users may play the scenario at step 1406. The scenario is played within the area scanned at step 1402 against or with the AI characters inserted at step 1404. While the scenario is being played at step 1406, the scenario may also be recorded at step 1408. This enables a user to go back and review the played scenario in order to improve training and learning purposes arising from the scenario. The scenario may additionally be replayed in a particular requested manner at step 1410 that is somewhat different from the manner in which the scenario was originally played at step 1406. This enables the scenario to be used for specific training purposes and to focus on particular areas with which the user had problems.

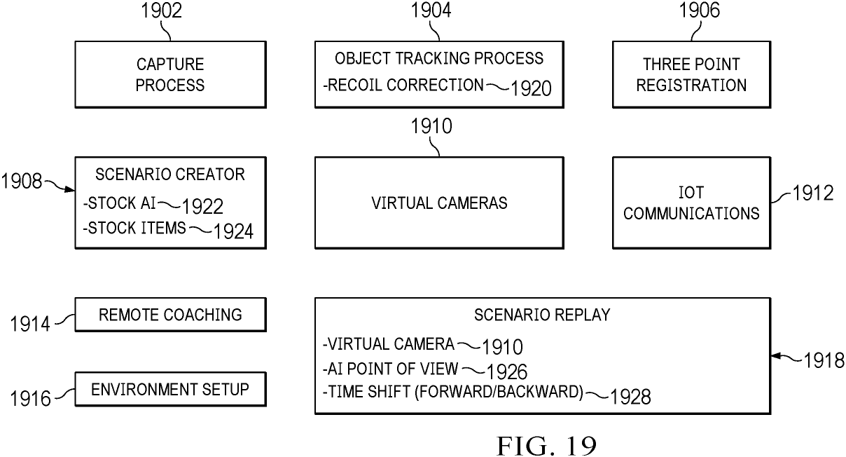

With respect to the scanning process referenced in step 1402 hereinabove, FIG. 15A illustrates the manner for combining scanning data from multiple scanning units in order to create a single AR/VR environment. A plurality of scanning units provides for the generation of multiple groups of scanning data 1502 that may be used for creating a single AR/VR environment. The multiple groups of scanner data 1502 may comprise overlapping portions of similar areas or may each comprise data with respect to a single same area or multiple different areas of the single area. The scanner data 1502 is combined together at 1504 to create a single group of data defining an AR/VR area. This single group of data is used for the generation of a single environment at 1506. This ability for combining the multiple groups of scanned data 1502 enable the creation of an AR/VR environment in a much quicker fashion wherein each user may scan different portions of an overall area enabling faster creation of the AR/VR environment. Alternatively, more particularized data of a scanned environment may be obtained by multiple devices scanning a same area in order to provide more detailed information upon the area in which the AR/VR environment is going to be created.

Referring now to FIG. 15B there are illustrated the components for scanning an environment using a central server 1534 to generate an AR/VR representation. Multiple mobile user devices 1530 such as a mobile telephone, iPad, etc. including depth and color sensors 1532 are used for scanning a particular 3-D environment 1534. The 3-D environment 1534 may comprise a building, room, parking lot or any other 3-D area in which a game or simulation will be performed for one or more users. The sensors 1532 collect color and depth data from the 3-D environment 1534 by scanning the 3-D environment. This scanned data is transmitted from the user devices 1530 to a central server 1534 via a wireless or wired connection. The central server 1534 utilizes the scanned data to generate at 1536 a polygon mesh of the 3-D environment 1534 that may be used to create an AR/VR environment for presentation to a user.

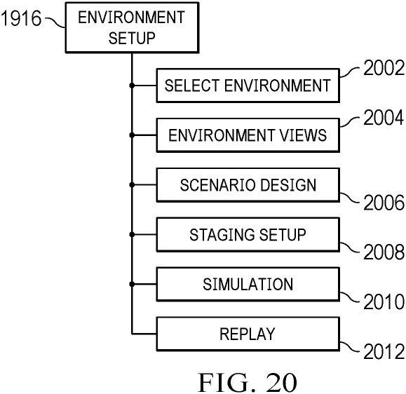

FIG. 16 more particularly illustrates the manner in which a scanning process may be initiated for determining a position of a user device 1530 for the creation of an AR/VR environment. An end-user device 1530 such as an iPad or mobile phone including depth and color sensors are connected at step 1602 to a central server 1534 that controls the generation of the AR/VR environment. The scanning devices 1530 are localized using three known points of reference. This involves randomly placing three distinct images at step 1604 within a particular environment at known locations. The end-user device localizes its position within the real world at step 1606 based upon detection of each of these images. The localization process uses SLAM (Simultaneous location and mapping) to determine the position of the user device 1530 relative to the real world. Each end-user device 1530 will recognize one of the three placed images as a known image in size and content and generate a position relative to its local space at step 1608. Inquiry step 1610 determines if each of the three placed images have been detected by a device 1530. If not, the user device 1530 begins looking for the next image at step 1612 and once detected will recognize the image and generate its position relative to its local space at step 1608 as described above. Once each of the three images are detected at inquiry step 1610, the detected images are used to generate a triangle and a central point at step 1614. The central point of the triangle relative to the end-user device is then provided to the central server at step 1616. The central server 1534 will then align the device at step 1618 based upon this provided information. Every time the central server 1534 sends clients updated transform data from other clients, the central point offset is applied to align the end user device with its position as determined by the central server.

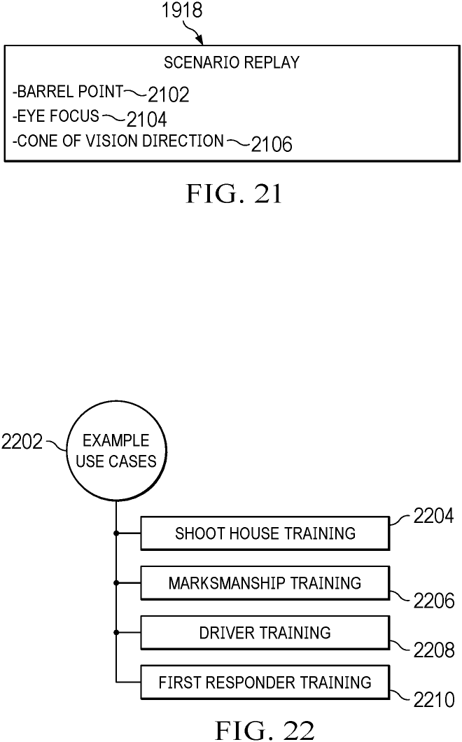

Referring now to FIG. 17, there is illustrated the process for using multiple devices 1530 to create an augmented reality/virtual reality environment. Multiple end-user devices 1530 containing depth and color sensors are connected at step 1702 to a central server 1534. The devices 1530 are localized at step 1704 using three known points of reference that have been previously established as described above with respect to FIG. 16. The depth sensors within each of the devices 1530 collect point cloud data at step 1706 from the depth sensors of each of the user devices. The central server 1534 transforms all of the received point data from end space to central server space at step 1708. The generated point cloud data is combined into a polygon mesh at step 1710 by the central server 1534. The generated polygon mesh is used to create an AR/VR world 1712 for presentation to a user.

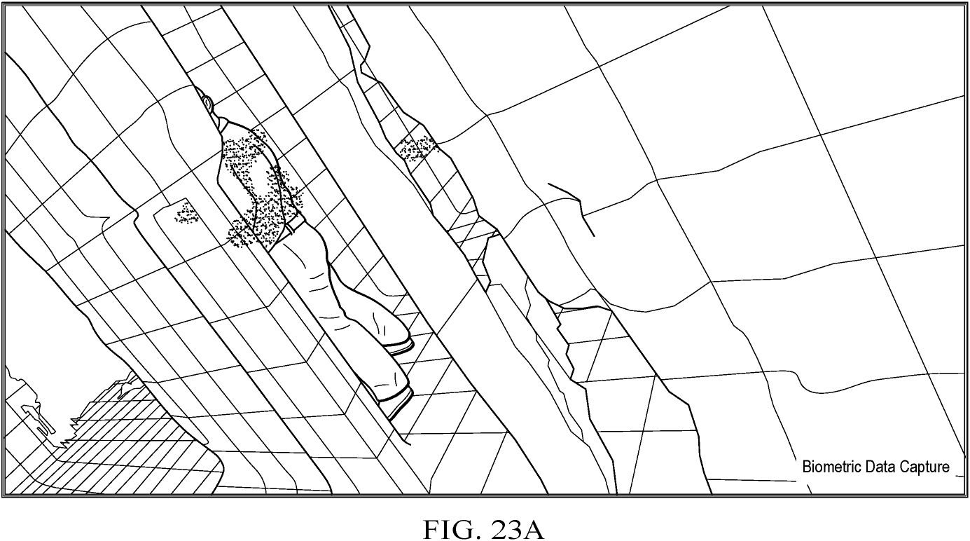

FIG. 18 more particularly illustrates the process of capturing an area and creating an augmented reality/virtual reality environment from the captured data. Initially, multiple end-user devices 1530 having depth and color sensors 1532 are connected to a central server 1534 at step 1802. Each of the user devices are localized at step 1804 using three known points of reference. Point cloud samples of depth and color data are collected at step 1806 by the end-user devices. The depth data is triangulated into a polygon mesh at step 1808. Color samples are assigned at step 1810 to the generated polygon mesh data. The generated mesh data and color samples are transmitted to the central server 1534 at step 1812. The central server 1534 assigns a name to the received data and create an AR/VR environment at step 1814. The central server 1534 transmits the generated AR/VR data to clients at step 1816.

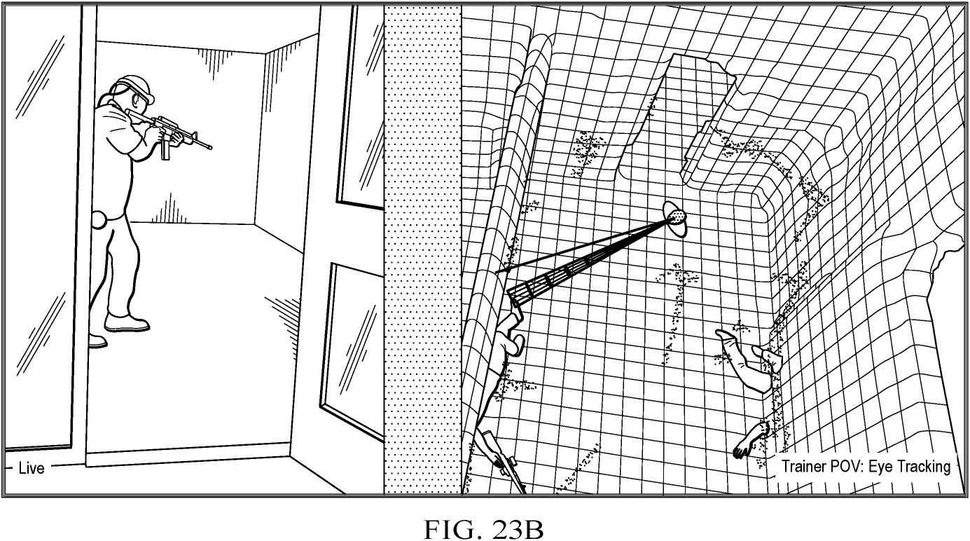

Referring now to FIG. 19, there are illustrated the various functionalities that are provided by the AR/VR system platform implemented on the central server 1534. The various functionalities include the capture process 1902, object tracking process 1904, three point registration 1906, scenario creator 1908, virtual cameras 1910, Internet of things communications 1912, remote coaching 1914, environment setup 1916 and scenario replay 1918. The capture process 1902 involves the capture of the physical environment that is being re-created as the AR/VR environment by the AR/VR system platform using for example the techniques described hereinabove with respect to FIGS. 16-18. Using these techniques user devices 1530 having color and depth sensors 1532 scan an environment which is provided to the AR/VR server for recreation as an AR/VR world. Object tracking processes 1904 involve the tracking of an object being held by the user within the AR/VR environment. Thus, when a user is carrying a rifle or pistol, the direction in which the rifle or pistol is being pointed is tracked by the AR/VR system platform so that a determination can be made as to where the user is aiming. This tracking would be accomplished utilizing, for example, the object trackers described in FIGS. 9-13 and the device tracking component 608 of the headset 512 described hereinabove. The object tracking functionalities 1904 with respect to rifles and pistols would further include recoil correction functionalities 1920. The recoil correction functionalities 1920 would account for and simulate recoil caused by firing of the weapon in the AR/VR world and alter the aiming of the weapon based upon the determined recoil correction and generate control signals to haptic feedback devices in an associated weapon to simulate recoil. The object tracking process 1904 may also be used to track other items within an AR/VR world such as a bat, tennis racket, golf club, etc. depending upon the particular game or training operation that is being provided by the platform.

The three point registration functionalities 1906 involve the ability to register a position of particular objects and of the user within the AR/VR environment. The AR/VR system platform utilizes a determination of three known points within the system to place a user and various objects within the environment in relation to the three known registration points. Examples of this are described hereinabove with respect to FIG. 16. A scenario creator 1908 enables the AR/VR system platform to establish a particular scenario for interaction with a user or game player. With respect to a training platform such as a shoot house for military personnel or law enforcement officer, the scenario creator 1908 enables the creation of a particular environment for testing an individual skill set. Thus, the scenario creator 1908 would establish, for example, a hostage situation wherein multiple “bad guys” were holding one or more hostages which have to be rescued. The scenario creator 1908 can include various options such as stock AIs 1922 that are placed within the scenario to be interacted with by the user/player. Each of the “bad guys” and hostages could be a stock AI that are programmed to react in a particular fashion. The scenario creator 1908 could also include various stock items 1924 that are included within a particular scenario interaction within the AR/VR world. Stock items 1924 may comprise things such as tables, chairs boxes, doorways, windows, screens, etc. that would potentially be useful in creating a real-world scenario for a user.

Virtual camera functionalities 1910 enable the platform to establish a virtual camera position within the AR/VR world and provide a view in either real time or playback mode of the view provided by the virtual camera that has been established. Thus, with respect to the shoot house scenario referenced above, a virtual camera position can be established for cameras located outside of the room to detect how users interacted prior to room entry, and a virtual camera position may also be established within the room to record how the users react once a particular room has been entered. The Internet of things (IOT) communications functionalities 1912 enable the platform and various components thereof to communicate with any number of Internet capable devices. The IOT communications functionalities 1912 would enable the system to communicate with components having cellular, Wi-Fi, Bluetooth or any other type of wireless communications capabilities. These IOT communications functionalities 1912 would also allow remotely located trainers to interact with the platform and provide instruction and communications to users in a real time fashion while a particular scenario was being experienced or developed. The remote coaching functionalities 1914 that utilize the IOT communications functionalities 1912 enable real-time feedback to be provided to users to improve the training aspects of the system.

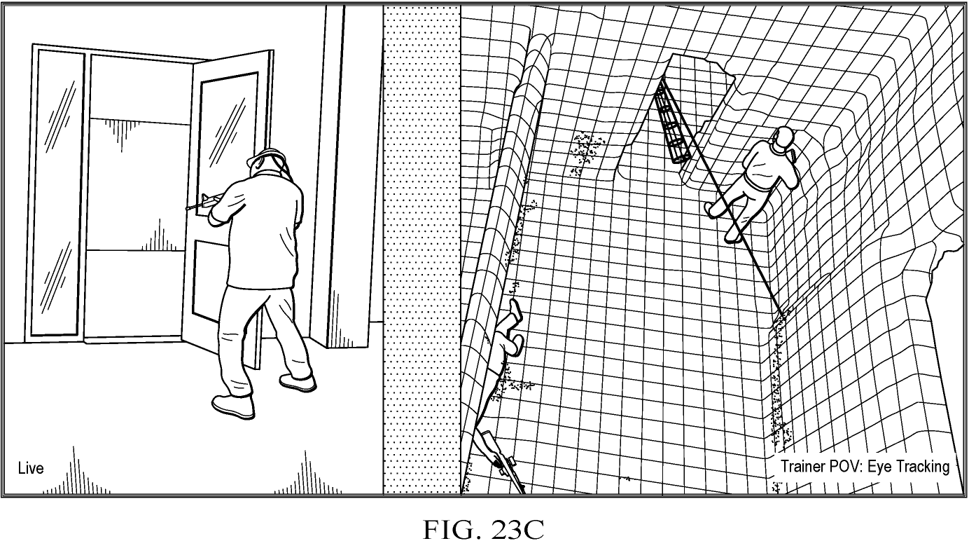

Environment setup functionalities 1916 enable a user to set up the particular environment that the user will interact with in the AR/VR world. The scenario creator 1908 is a sub function of the environment setup functionalities 1916. FIG. 20 illustrates various environmental setup functionalities 1916 provided by the AR/VR system platform. The select environment functionality 2002 enables the selection of the particular training/gaming environment that a user will interact with through the AR/VR system platform. The select environment functionality 2002 enables a user to select a particular environment that will be interacted with by the user, a particular scenario within the environment that is being interacted with by the user or to create a particular scenario that the user will interact with utilizing the scenario creator 1908. The selected environment can be created by the user and have associated therewith an environment image and environment name that is saved with respect to the created environment for access at a future time. The environment setup functionalities 1916 may also include selection of various environment views 2004. The environment views enable a creation of point of view virtual camera locations that are associated with hotkeys for quick access to multiple views as described above. The user may interact with the AR/VR system platform through a user interface and utilize a mouse to position a view and then right-click the mouse in order to establish the camera position. Movement of the mouse will change the camera angle that is being viewed by the POV camera. Once the POV camera position is established, the user may identify the camera with a particular identifier and return to the camera to observe the established view at a later point in time.

The environmental setup functionalities 1916 may also provide for scenario design 2008 using the previously discussed scenario creator 1908. The scenario design functions 2008 enable the user to select an existing scenario or create a new one. Various AI actors and prop options may be inserted into the scenario utilizing the stock AI 1922 and stock items 1924. Once created, the scenario is saved with a particular name and description for access in the future. The environmental setup functionalities 1916 may also provide for staging set up 2008. Staging set up 2008 allows for the user to verify roles of users and weapon assignments of users within the AR/VR system platform. The staging set up 2008 would allow a user’s role within a particular scenario to be confirmed such as hostage, hostage taker, rescuer, etc. Additionally, the confirmation that a particular weapon was associated with a particular user may be perfomed. The simulation functions enable the scenario to be executed in accordance with the established parameters. The user would interact with the scenario and the established AI’s within the scenario until the scenario was completed or ended. The replay functionalities 2012 enables a previously played scenario to be replayed for review and assessment by the user and any other training personnel. Thus, once the user has gone through a particular scenario and interacted with the components thereof, the scenario may be replayed to the user for training purposes and portions of the scenario reviewed in order to improve user performance. Replay functionalities would enable the previously played scenario to be rewound, fast forwarded or paused from the recorded version of the scenario. The recorded scenario may be saved and renamed with a new file name and within the replayed scenario the point of view cameras positions may be changed to any of those established by the previously set up virtual camera positions.

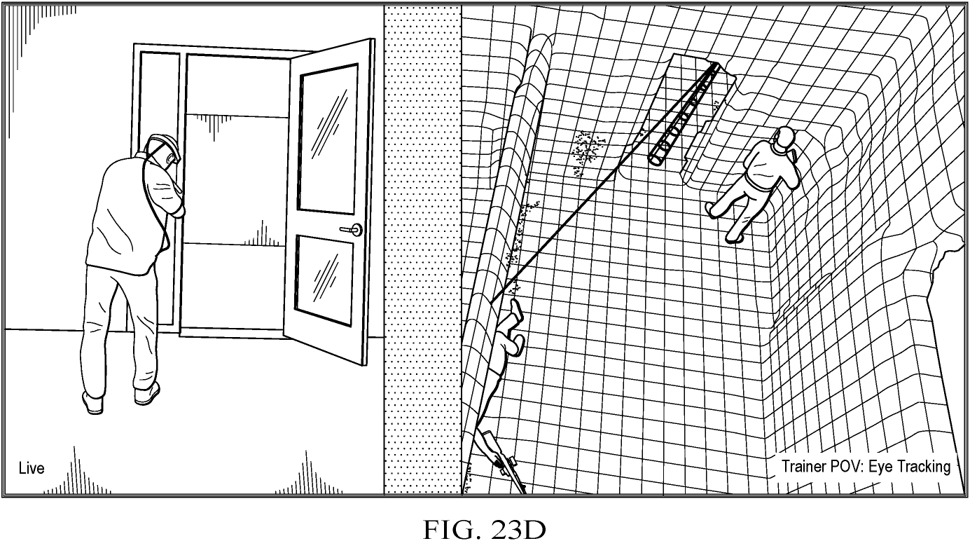

Referring now also to FIG. 21, the scenario replay functionalities 1918 may record a variety of information with respect to the played scenario. In addition to those elements discussed above, the scenario replay may further record and replay information with respect to the barrel pointing direction 2102 of a user’s rifle or pistol. The user headset enables tracking and recording of the eye focus 2104 of the user during playing of the scenario and may further track and display a cone of vision direction 2106 of the user playing the scenario. In a normal viewing situation, an individual has a cone of vision that provides a wide angle of view of items which are within the individual’s vision. However, within this cone of vision the user will normally particularly focus on a particular item or area within the cone of vision. Thus, for example, in a shoot house scenario, the user may see an entire portion of a room including a hostage and two hostage takers within a cone of vision 2106 once a room is entered by the user. However, the eye focus 2104 of the user within the cone of vision 2106 may be focused on a particular hostage taker that currently provides a highest degree of threat to the hostage or the user within the scenario. These would all be illustrated by the eye focus function 2104 and cone of vision function 2106.

Additional training benefits are provided by the various scenario replay functionalities 1918 provided by the system. These replay functionalities 1918 may comprise components such as the virtual cameras 1910 described hereinabove, the point of view of the AI 1926, time-shifting 1928 either forward or backward within the scenario. In this way the scenario can be reviewed from a number of points of view and in a number of different time increments.

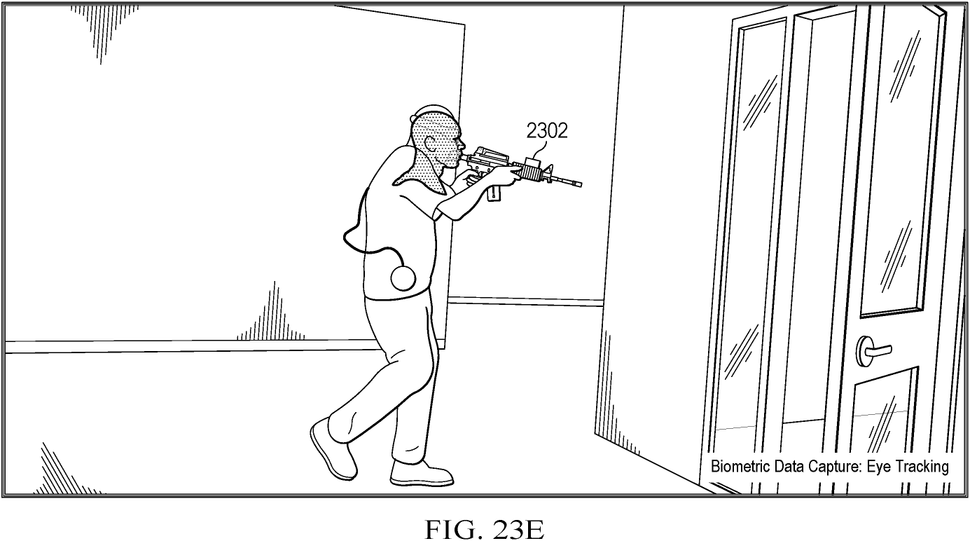

The above described system, has been referenced with respect to a user within a shooting training scenario for soldiers or law-enforcement officers. However, it should be appreciated that a variety of different applications may be utilized with respect to the AR/VR system platform. As shown in FIG. 22, various example use cases 2202 include a shoot house scenario 2204 as described hereinabove, marksmanship training 2206 for providing target practice training to individuals, driver training 22 for providing driver training for various high risk driving scenarios first responder training 2210 for training first responders in high risk scenarios such as fires, floods, etc. in order that they may be more familiar with their options within these scenarios or game playing environments. The above example use cases 2202 are merely examples and a variety of different uses may be provided using the AR/VR system platform as described herein for both training and entertainment purposes.

The shoot house scenario 2204 would allow a user to perform enter and clear a room training drills with unlimited variability using dry fire weapon systems. The scenario would operate in an indoor warehouse space of up to 50,000 ft.² in size. Teams can clear rooms versus an opposing force that is controlled via AI or SMEs to provide unlimited training variability within a same physical environment. The environment can comprise a digital twin of a real-world location for use in the simulation. Analytics collected during training repetitions include locations where the user was looking, where the muzzle was pointed, the heartbeat of the user, trigger pulls and where and when a virtual round hits. The system records each rep for instant AAR (after action review) within the real environment. Remote experts may observe and dynamically change the threats or noncombatants. The system may provide instruction based upon the analytics and observed actions. Each user’s actions can be recorded to show progress along desired KPIs over time.

The marksmanship training 2206 performs range prequalification training using dry fire weapon systems without going to an actual firing range. The system may operate within an indoor room of approximately 8′ x 8′. The use case brings the range to the user by simulating real-world wind, atmosphere and temperature. The user can select from a number of real-world outdoor ranges. The system collects analytics per user in order to track user progress over time. A digital twin of a real-world firing range may be simulated using photogrammetry or traditional 3-D art pipeline and tools. This implementation would reduce the amount of real-world range time that was needed, reduce ammunition cost of range training and increase the reps and sets of range qualifications before on-site testing. Remote assistance an expert instructions increases the impact of training without incurring travel and co-location costs. Data collected per shot and per session can be associated with the user to track their progress.

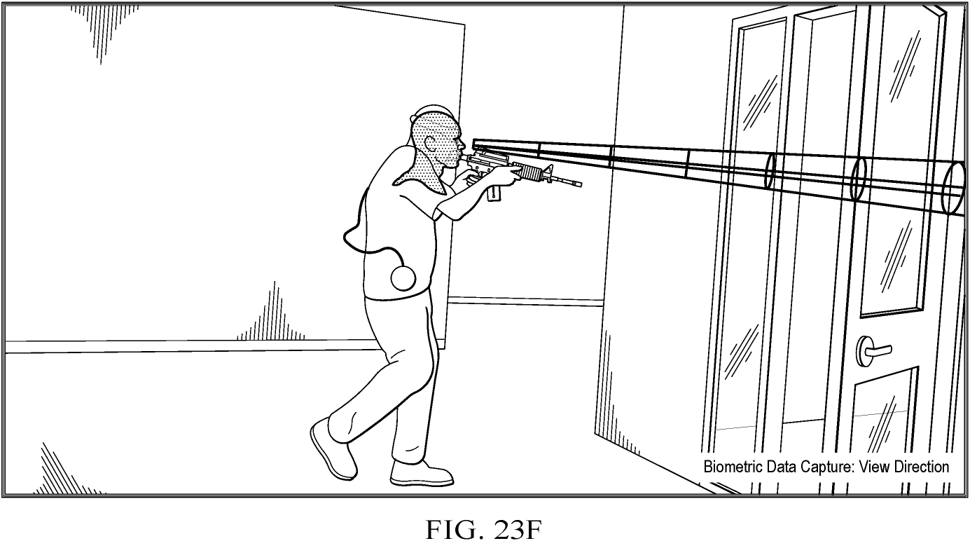

Referring now to FIGS. 23A-23F there are illustrated a variety of screenshots with respect to a scenario replay associated with a shoot house scenario as described hereinabove. The FIG. 23A illustrates a screenshot of a biometric data capture. The biometric data capture provides the created mesh environment created from the captured data as described hereinabove. FIG. 23B 23C and 23D illustrates the trainer POV eye tracking for a user playing through a scenario and records the eye tracking of the individual with respect to the AR/VR environment. FIG. 23E illustrates the biometric data capture for the eye tracking. This comprises the point tracking that monitors the particular point within the AV/VR environment that a user is focusing on during interaction with a scenario. FIG. 23F illustrates the biometric data capture for the view direction. This illustrates the cone of vision of the user at a particular point in time.

It will be appreciated by those skilled in the art having the benefit of this disclosure that this virtual reality training system provides an improved manner for training individuals or providing a more efficient entertainment system. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A system for providing an augmented reality/virtual reality (AR/VR) environment, comprising:
an AR/VR server for providing an AR/VR environment responsive to scanned environment data, control data and user device data;
a portable user device associated with the AR/VR server for generating the user device data for transmission to the AR/VR server and for displaying the AR/VR environment to a user associated with the portable user device;
wherein the AR/VR server is further configured to:
receive the scanned environment data from at least one scanning device, the scanned environment data representing a physical environment;
generate the AR/VR environment responsive to the scanned environment data;
create a scenario within the generated AR/VR environment responsive to the control data provided to the AR/VR server;
track a position of a gun held by the user responsive to feedback from the gun to the portable user device;
determine a recoil associated with the tracked position of the gun; and
simulate the recoil caused by firing of the gun by adjusting the tracked position of the gun within the AR/VR environment responsive to the determined recoil; and
control the position of the gun and the aiming of the gun within the AR/VR environment responsive to the adjusted tracked position of the gun.

2. The system of claim 1, wherein the portable user device further comprises:
processing circuitry wearable by the user for transmitting and receiving AR/VR environment data relating to the AR/VR environment; and
a headset for displaying the AR/VR environment to the user responsive to the AR/VR environment data from the AR/VR server.

3. The system of claim 2, wherein the headset further comprises:
a display for providing a 3-D representation of the AR/VR environment to the user responsive to the AR/VR environment data from the AR/VR server;
device tracking circuitry for tracking the position of the gun held by the user responsive to LED lights detected on the gun; and
vision tracking circuitry for tracking a focus point that the user is focusing on in the AR/VR environment and a cone of vision of the user within the AR/VR environment.

4. The system of claim 3, wherein AR/VR server is further configured to store for playback the focus point and cone of vision tracked by the vision tracking circuitry.

5. The system of claim 2, wherein the processing circuitry further comprises:
a video processor for generating the AR/VR environment for display by the headset responsive to the AR/VR environment data; and
a system processor for controlling operation of the AR/VR environment presented to the user responsive to the control data received from the AR/VR server.

6. The system of claim 1, wherein the AR/VR server is further configured to generate control signals to a haptic feedback device associated with the gun.

7. The system of claim 1, wherein the AR/VR server is further configured to create the scenario by adding stock AIs and stock items to the AR/VR environment responsive to the control data.

8. The system of claim 1, wherein the AR/VR server is further configured to place a virtual camera within the AR/VR environment at a selected location responsive to the control data, the virtual camera providing a view of the AR/VR environment associated with the selected location.

9. The system of claim 1, wherein the AR/VR server may dynamically alter the scenario within the generated AR/VR environment responsive to the control data while the scenario is being carried out within the generated AR/VR environment.

10. A system for providing an augmented reality/virtual reality (AR/VR) environment, comprising:
an AR/VR server for providing an AR/VR environment responsive to scanned environment data, control data and user device data;
a headset for displaying the AR/VR environment to a user responsive to AR/VR environment data from the AR/VR server;
vision tracking circuitry associated with the headset for tracking a focus point that the user is focusing on in the AR/VR environment and a cone of vision of the user within the AR/VR environment;
wherein the AR/VR server is further configured to:
receive the scanned environment data from at least one scanning device, the scanned environment data representing a physical environment;
generate the AR/VR environment responsive to the scanned environment data;
create a scenario within the generated AR/VR environment responsive to the control data provided to the AR/VR server;
track a position of an object held by a user responsive to feedback from the object to a portable user device;
control the position of the object within the AR/VR environment responsive to the tracked position of the object by the portable user device; and
storing for playback the focus point and cone of vision tracked by the vision tracking circuitry.

11. The system of claim 10, wherein the object comprises a gun and the AR/VR server is further configured to:
determine a recoil associated with the tracked position of the gun;
simulate the recoil caused by firing of the gun by adjusting the tracked position of the gun within the AR/VR environment responsive to the determined recoil; and
control the position of the gun and the aiming of the gun within the AR/VR environment responsive to the adjusted tracked position of the gun.

12. The system of claim 10, wherein the AR/VR server is further configured to create the scenario by adding stock AIs and stock items to the AR/VR environment responsive to the control data.

13. The system of claim 10, wherein the AR/VR server is further configured to place a virtual camera within the AR/VR environment at a selected location responsive to the control data, the virtual camera providing a view of the AR/VR environment associated with the selected location.

14. The system of claim 10, wherein the AR/VR server may dynamically alter the scenario within the generated AR/VR environment responsive to the control data while the scenario is being carried out within the generated AR/VR environment.

15. The system of claim 10 wherein the AR/VR server is further configured to:
record the scenario as the scenario is carried out by the user; and
play back portions of the recorded scenario responsive to control signals.

16. A system for providing an augmented reality/virtual reality (AR/VR) environment, comprising:
a portable user device associated with an AR/VR server for generating user device data for transmission to the AR/VR server and for displaying an AR/VR environment to a user associated with the portable user device, wherein the portable user device further comprises:
processing circuitry wearable by the user for transmitting and receiving AR/VR environment data relating to the AR/VR environment; and
a headset for displaying the AR/VR environment to the user responsive to the AR/VR environment data from the AR/VR server
vision tracking circuitry associated with the headset for tracking a focus point that the user is focusing on in the AR/VR environment and a cone of vision of the user within the AR/VR environment.

17. The system of claim 16, wherein the headset further comprises:
a display for providing a 3-D representation of the AR/VR environment to the user responsive to the AR/VR environment data from the AR/VR server;
device tracking circuitry for tracking the position of an object held by the user responsive to LED lights detected on the object.

18. (canceled)

19. The system of claim 16, wherein the processing circuitry further comprises:
a video processor for generating the AR/VR environment for display by the headset responsive to the AR/VR environment data; and
a system processor for controlling operation of the AR/VR environment presented to the user responsive to control data received from the AR/VR server.

20. The system of claim 16, wherein the portable user device is mounted on a vest that is wearable by the user.
